(19) United States
(12) Patent Application Publication
(10) Pub. No.: US 2026/0220885 A1
(43) Pub. Date: Jul. 30, 2026

(54) REAL TIME OPTIMIZATION OF IMAGING PARAMETERS IN 3D OPTICAL DEVICES

(71) Applicant: TEXAS INSTRUMENTS INCORPORATED, Dallas, TX (US)

(72) Inventors: Jaime Rene DE LA CRUZ VAZQUEZ, Carrollton, TX (US); Samuel Edward MARTIN, Dallas, TX (US)

(21) Appl. No.: 19/036,987

(22) Filed: Jan. 24, 2025

(51) Int. Cl. G06T 17/00

(52) U.S. Cl. CPC G06T 17/00

(57) ABSTRACT

A device includes a projector to project a pattern, a camera to capture an image of a reflection of the pattern, and a processor to determine multiple intersection points of first and second sets of rays in 3d space, the first set of rays corresponding to the pattern having and the second set of rays corresponding to the pattern in the captured image; determine a set of 3d point clouds responsive to the multiple intersection points and a set of values for a parameter in a parametric model of the projector or camera; compare each of the set of 3d point clouds to a target set of pixels to determine a set of residues; select a value of the set of values responsive to the set of residues; and display an image of an object in an environment of the device with the selected value assigned to the parametric model.

### BACKGROUND

Three-dimensional (3d) metrology is the study of measuring objects in three dimensions. 3d metrology is useful in various applications, such as virtual reality, augmented reality, industrial automation, automotive, and healthcare systems. In virtual and augmented reality systems, embedded projectors and cameras are used to precisely measure and map three-dimensional spaces to enable accurate spatial awareness and interaction within virtual environments. By capturing depth information using projectors and cameras, these systems use 3d metrology to create digital representations of the physical surroundings, allowing virtual objects to align and respond accurately to real-world elements.

### SUMMARY

A device includes a projector to project a pattern, a camera to capture an image of a reflection of the pattern, and a processor to determine multiple intersection points of first and second sets of rays in 3d space, the first set of rays corresponding to the pattern having and the second set of rays corresponding to the pattern in the captured image; determine a set of 3d point clouds responsive to the multiple intersection points and a set of values for a parameter in a parametric model of the projector or camera; compare each of the set of 3d point clouds to a target set of pixels to determine a set of residues; select a value of the set of values responsive to the set of residues; and display an image of an object in an environment of the device with the selected value assigned to the parametric model.

A method includes determining, by a processor, a set of three-dimensional (3d) point clouds, the 3d point cloud in the set of 3d point clouds responsive to different values for a parameter in an imaging device parametric model; determining, by the processor, that a first 3d point cloud of the 3d point clouds most closely matches a target set of pixels; and producing, by the processor, an image of an environmental object with the value used to determine the first 3d point cloud assigned to the imaging device parametric model.

### BRIEF DESCRIPTION OF THE DRAWINGS

FIG. 1A is a block diagram of an optical device configured to optimize imaging parameters in real time, in accordance with various examples.

FIG. 1B is a diagram of an optical device configured to optimize imaging parameters in real time, in accordance with various examples.

FIG. 2 is a block diagram of an optical device configured to optimize imaging parameters in real time, in accordance with various examples.

FIG. 3 is a flow diagram of a method for optimizing imaging parameters of an optical device in real time, in accordance with various examples.

FIGS. 4A-4C are schematic diagrams of a projected pattern, a captured image of the projected pattern, and a 3d point cloud generated using the projected pattern and the captured image, in accordance with various examples.

FIG. 5 is a schematic diagram of a portion of a method for optimizing imaging parameters of an optical device in real time, in accordance with various examples.

FIG. 6 is a schematic diagram of a portion of a method for optimizing imaging parameters of an optical device in real time, in accordance with various examples.

FIG. 7 is a schematic diagram of a portion of a method for optimizing imaging parameters of an optical device in real time, in accordance with various examples.

FIG. 8 is a schematic diagram of a portion of a method for optimizing imaging parameters of an optical device in real time, in accordance with various examples.

FIG. 9 is a graph of a portion of a method for optimizing imaging parameters of an optical device in real time, in accordance with various examples.

FIGS. 10-13 are graphs depicting applications of methods for optimizing imaging parameters of an optical device in real time, in accordance with various examples.

### DETAILED DESCRIPTION

Certain optical devices, such as embedded vision devices, include both a projector and a camera to facilitate interaction with the environment. For example, an augmented reality headset may use both a projector and a camera built into the frame of the headset to create models of the user’s environment in real-time, thereby facilitating interaction with the environment. To create such environmental models, the optical device uses the projector to project a pattern or other suitable visual element onto an object in the environment. The optical device captures an image of the pattern from the object. The optical device models the projected pixels and the pixels in the captured image as light rays in 3d space. The optical device determines the locations at which these light rays intersect in 3d space and uses these locations to generate a 3d point cloud, which serves as a model of the environmental object. In generating the 3d point cloud, the optical device relies on specific assumptions about the intrinsic parameters of the camera and the projector. These assumptions about the parameters of the camera and projector may be referred to as parametric models of the camera and the projector. If the assumptions in the parametric models are accurate, the 3d point cloud may be accurate, thus facilitating the proper operation of the optical device. However, if one or more of the assumptions in the parametric models is inaccurate, the 3d point cloud may likewise be inaccurate, thus hindering the proper operation of the optical device.

Similar problems exist in other types of optical devices. For example, in the automotive industry, optical devices that integrate projectors and cameras are increasingly employed for advanced driver assistance systems (ADAS) and autonomous vehicle navigation. For example, a LiDAR system may use a projector to emit laser pulses and a camera or sensor to capture the reflections of those pulses from surrounding objects. The device uses the timing and intensity of the reflected signals to map the environment in three dimensions, enabling features such as obstacle detection, lane-keeping, and adaptive cruise control. Similar to augmented reality devices, the system relies on accurate parametric models of the camera and projector to generate precise 3D point clouds of the vehicle's surroundings. Any deviation in these parametric assumptions can lead to errors in environmental modeling, potentially reducing the reliability of safety features or autonomous decision-making processes.

Similarly, in the healthcare industry, optical devices combining projectors and cameras are useful for precise medical imaging and diagnostic applications. For example, 3D optical scanners in prosthetics design use a projector to cast structured light patterns onto a patient's body part and a camera to capture the distorted patterns. The system analyzes these distortions to reconstruct a 3D model of the scanned area, which can then be used for custom prosthetic design or surgical planning. Accurate parametric models of the camera and projector are useful to facilitate 3D models that reflect patient anatomy with high fidelity. Inaccuracies in parametric assumptions could result in errors that compromise the quality of prosthetic fittings or the precision of surgical interventions.

To facilitate accurate 3d point cloud generation, the optical device makes continuous adjustments to some of the actual parameters of the projector or camera, as certain intrinsic values are dynamic and do not remain constant over time. For example, the focal length and principal point parameters of the projector or camera may change over time (e.g., due to zoom or lens shift). These variations in dynamic parameters can lead to discrepancies between the assumed parameter values in the parametric models (e.g., in software) and the actual parameter values implemented in the projector or camera hardware, resulting in distortions in the 3d point cloud and improper operation of the optical device. To counteract this, the optical device frequently recalibrates these parameters by projecting a pattern, capturing the pattern with the camera, and using the captured image to correct the parametric models for any drift in the projector or camera hardware parameters. While this calibration process can help maintain 3d point cloud accuracy, the process is computationally demanding.

This description presents various examples of optical devices (e.g., augmented reality devices, virtual reality devices, automotive devices, medical devices, etc.) configured to optimize imaging parameters (e.g., dynamically variable projector and camera parameters, such as focal length, principal point, resolution, and distortion) in real-time. Rather than repeatedly projecting and capturing calibration images, which, as described above, is computationally intensive, an example optical device described herein projects and captures a single image. The example optical device subsequently generates a set of 3d point clouds using the projected and captured image and by varying the parameter(s) used to generate the point clouds across a range of possible values. The example optical device compares each of the 3d point clouds to a target set of pixels (e.g., the pixels on the projector image plane) and determines a residue, or error, associated with each of the 3d point clouds. The optical device identifies the 3d point cloud with the smallest residue and assigns the parameters used to generate that 3d point cloud to the parametric models of the projector and camera. In this way, the parameters in the parametric models that are subsequently used to generate the 3d point clouds during operation (e.g., to create models of the environment) will be accurate, leading to accurate 3d point clouds and thus accurate environmental models. Further, because this process is primarily a numerical and geometric process performed by a processor in response to executable commands and entails a negligible use of the projector and camera, the process is computationally fast and efficient. More specifically, because the process described herein is primarily numerical and geometric, the process does not require repeated parametric recalibrations (as described above), additional sensors or other hardware equipment, or additional inputs from the user or other person or entity. Thus, the process is highly efficient both in terms of hardware costs and computational load.

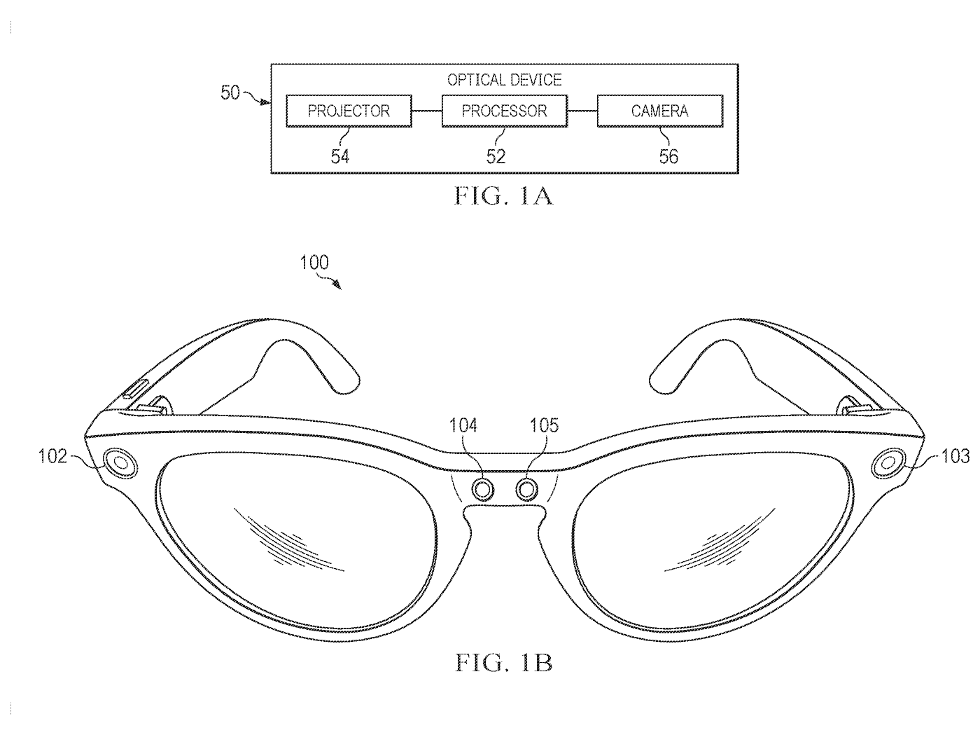

FIG. 1A is a block diagram of an optical device configured to optimize imaging parameters in real time, in accordance with various examples. More specifically, FIG. 1A depicts an optical device 50, such as an automobile, aircraft, space craft, military vehicle, video game headset, robotic appliance (e.g., vacuum cleaner), industrial robot, smart imaging device, medical imaging equipment, smartphone, projector, or laser television. The optical device 50 may include a processor 52 coupled to a projector 54 and a camera 56. The processor 52 is configured to operate the projector 54 and the camera 56. The projector 54 is configured to project images (e.g., patterns of multiple pixels), and the camera 56 is configured to capture images (e.g., reflections of patterns of multiple pixels). In some examples, the projector 54 includes an illumination source and/or spatial light modulator. In some examples, the illumination source and/or spatial light modulator may be external to the projector 54, for instance, as a component(s) of the optical device 50 but external to the projector 54, or for instance, as a component(s) external to the optical device 50. In some examples, the projector 54 may not require a separate illumination source and spatial light modulator, as with microLED and microOLED devices, which may be representative of the optical device 50.

The projector 54 may project a pattern, such as a grid of equally-spaced pixels, onto an object in the environment of the optical device 50. Such objects may be humans, animals, inanimate objects, etc. The camera 56 may capture an image of the pattern as projected on the environmental object. As described below, the optical device 50 may subsequently generate a set of 3d point clouds using the projected pattern, the captured image of the projected pattern, and a set of values for dynamically variable parameters in parametric models of the camera 56 and the projector 54, with each 3d point cloud in the set of 3d point clouds corresponding to a different parameter value or a different combination of parameter values.

For example, the focal lengths of the camera 56 and the projector 54 are dynamically variable parameters, meaning that the focal length of the camera 56 and the focal length of the projector 54 can be changed during use. The actual focal lengths of the camera 56 and the projector 54 may not be known during use. However, the optical device 50 uses these focal lengths to model objects in the environment. For instance, in an autonomous vehicle, the optical device 50 may need these focal lengths to accurately model buildings along a street to avoid collisions. Because the actual focal lengths of the camera 56 and the projector 54 are unknown, the optical device 50 assumes the values of these focal lengths. However, the assumed focal lengths may not match the actual focal lengths of the camera 56 and projector 54 hardware, and consequently, the optical device 50 may model environmental objects (e.g., buildings) incorrectly.

Accordingly, the optical device 50 may generate the aforementioned set of 3d point clouds. Each of these 3d point clouds represents a slightly different attempt at modeling the environmental object. The optical device 50 may use the same aforementioned projected pattern and the same aforementioned captured image of the projected pattern when generating each of the 3d point clouds. However, the difference between the 3d point clouds in the set of 3d point clouds is the assumed focal length. For instance, the optical device 50 may generate the first 3d point cloud with an assumed focal length of 40 mm, the second 3d point cloud with an assumed focal length of 39 mm, the third 3d point cloud with an assumed focal length of 38 mm, and so on. The set of 3d point clouds may include dozens, hundreds, or thousands of such 3d point clouds. In the case that both the camera 56 and projector 54 have variable focal lengths, the assumed focal length of the camera 56 may be held constant while the projector 54 assumed focal lengths are varied, and then the assumed focal length of the camera 56 may be again held constant at a different value while the projector 54 assumed focal lengths are varied again. For instance, the assumed focal length of the camera 56 may be held constant at 10 mm while the assumed focal length of the projector 54 is varied from 10 mm to 40 mm, with a different 3d point cloud generated for each combination of assumed focal lengths. Next, the assumed focal length of the camera 56 may be held constant at 11 mm while the assumed focal length of the projector 54 is varied from 10 mm to 40 mm, with a different 3d point cloud generated for each combination of assumed focal lengths. This process may be iterated until 3d point clouds for some or all possible combinations of the assumed focal lengths of the camera 56 and the projector 54 are generated and included in the set of 3d point clouds.

After generating the set of 3d point clouds, the optical device 50 compares each 3d point cloud in the set to a target set of pixels (e.g., the pixels on the image plane of the projector), as described below. The optical device 50 identifies the 3d point cloud in the set that most closely matches the target set of pixels, for example, by calculating a residue value of each 3d point cloud based on the comparison. The assumed focal lengths that were used to generate the identified 3d point cloud are the actual focal lengths of the camera 56 and projector 54 hardware, or are at least the closest available approximations of the actual focal lengths. Thus, these specific assumed focal lengths are assigned to the parametric models stored in the optical device 50 that describe the camera 56 and the projector 54. When the optical device 50 subsequently generates a model of an environmental object, the optical device 50 will access these specific assumed focal lengths from the parametric models of the camera 56 and the projector 54 and will use these assumed focal lengths to generate and display the model. The displayed model will be accurate, because the assumed focal lengths used to generate the model are identical or nearly identical to the actual focal lengths of the camera 56 and projector 54 hardware.

The optical device 50 stores, or has access to, a parametric model for the camera 56 and a parametric model for the projector 54. These parametric models are assumed parameters that the optical device 50 may access and use to generate 3d point cloud models of environmental objects. One goal of the process described above is to maintain accurate, up-to-date parametric models for the camera 56 and the projector 54, so that there is a high degree of certainty that any 3d point cloud models of environmental objects generated by the optical device 50 are accurate and reliable. A parametric model may include any number of assumed parameters, such as focal length, principal point, resolution, and distortion. The parametric models may include dynamically variable parameters and may exclude static parameters that are set during manufacture and that subsequently remain unchanged.

FIG. 1B is a diagram of an optical device configured to optimize imaging parameters in real time, in accordance with various examples. More particularly, FIG. 1B depicts an optical device 100 representative of the optical device 50 (FIG. 1A) and including multiple projectors 102, 103 and multiple cameras 104, 105. For example, the optical device 50 is a pair of augmented reality glasses. Although FIG. 1B depicts multiple projectors 102, 103 and multiple cameras 104, 105, in various examples, any number of projectors (i.e., one or more) may be included, and any number of cameras (i.e., one or more) may be included.

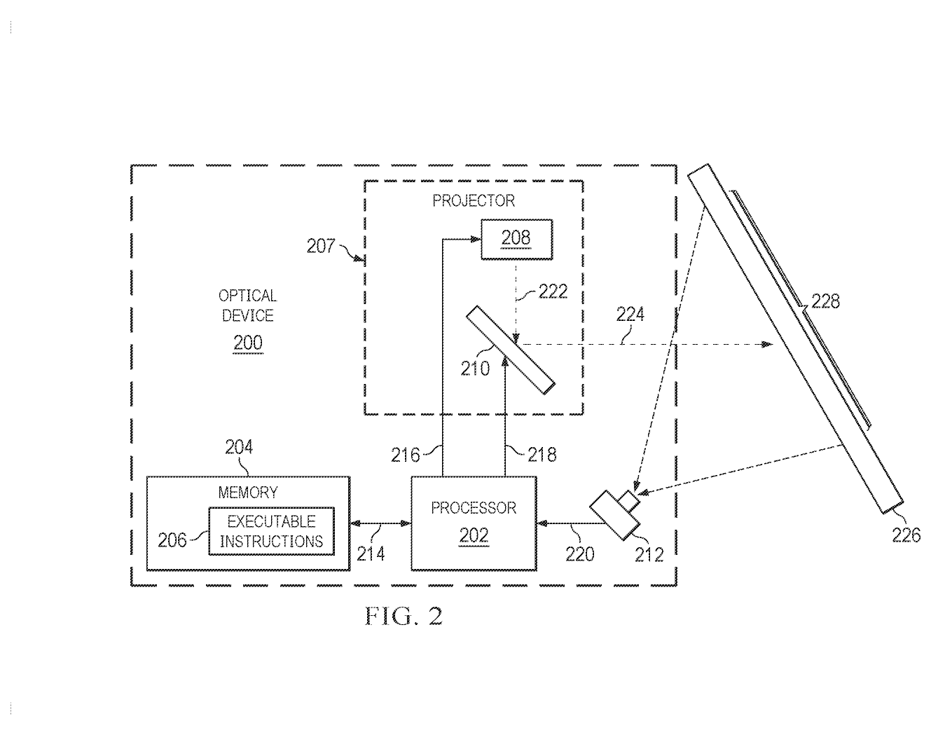

FIG. 2 is a block diagram of an optical device configured to optimize imaging parameters in real time, in accordance with various examples. Specifically, FIG. 2 depicts an optical device 200 (e.g., the optical device 50 of FIG. 1A, the optical device 100 of FIG. 1B) including a processor 202 (e.g., the processor 52 of FIG. 1A), a memory 204 (e.g., a non-transitory, computer-readable medium), a projector 207 (e.g., the projector 54 of FIG. 1A, the projectors 102, 103 of FIG. 1B), and a camera 212 (e.g., the camera 56 of FIG. 1A, the cameras 104, 105 of FIG. 1B). The memory 204 may store executable instructions 206, which, when executed by the processor 202, cause the processor 202 to perform some or all of the operations attributed herein to any component of the optical device 200. The projector 207 includes a light source 208 and a light modulator 210, although other types of projectors not having separate light sources and modulators, such as microLED and microOLED, are included in the scope of this disclosure as examples of the projector 207. A connection 214 couples the processor 202 to the memory 204. A connection 216 couples the processor 202 to the light source 208. A connection 218 couples the processor 202 to the light modulator 210. A connection 220 couples the processor 202 to the camera 212.

The processor 202 may operate the light source 208 to provide light to the light modulator 210, as numeral 222 indicates. The processor 202 may operate the light modulator 210 to modulate the received light and to project images (e.g., the pattern described above) to an environmental object 226 (e.g., a screen, a wall, a road, a car, a building, a person, an animal, a natural feature such as a body of water, a mountain, or vegetation, etc.), as numeral 224 indicates. In some examples, the processor 202 operates a self-emissive display technology like microLED or microOLED, in which the light modulator is integrated within a display panel. In such examples, the processor 202 dynamically adjusts the brightness and color of each pixel by modulating the current or voltage applied to the self-emissive diodes in the display.

The processor 202 operates the light modulator 210 to form an image 228 on the environmental object 226. The processor 202 operates the camera 212 to capture the image 228 of the pattern projected by the light modulator 210. In this way, the processor 202 has access to both the projected pattern and the captured image of the projected pattern. (The terms “projected pattern” and “projected multiple pixels” are interchangeably used herein. The terms “captured image of the projected pattern” and “captured image of the projected multiple pixels” are interchangeably used herein.) For example, the memory 204 may store the projected pattern and the captured image of the projected pattern. The processor 202 may then perform the operations attributed herein to the optical devices 50, 100, and/or 200, such as the generation of a set of 3d point clouds, identification of the 3d point cloud with the lowest residue, and assignment of the assumed parameters used to generate the identified 3d point cloud to the parametric models for the camera 212 and the projector 207.

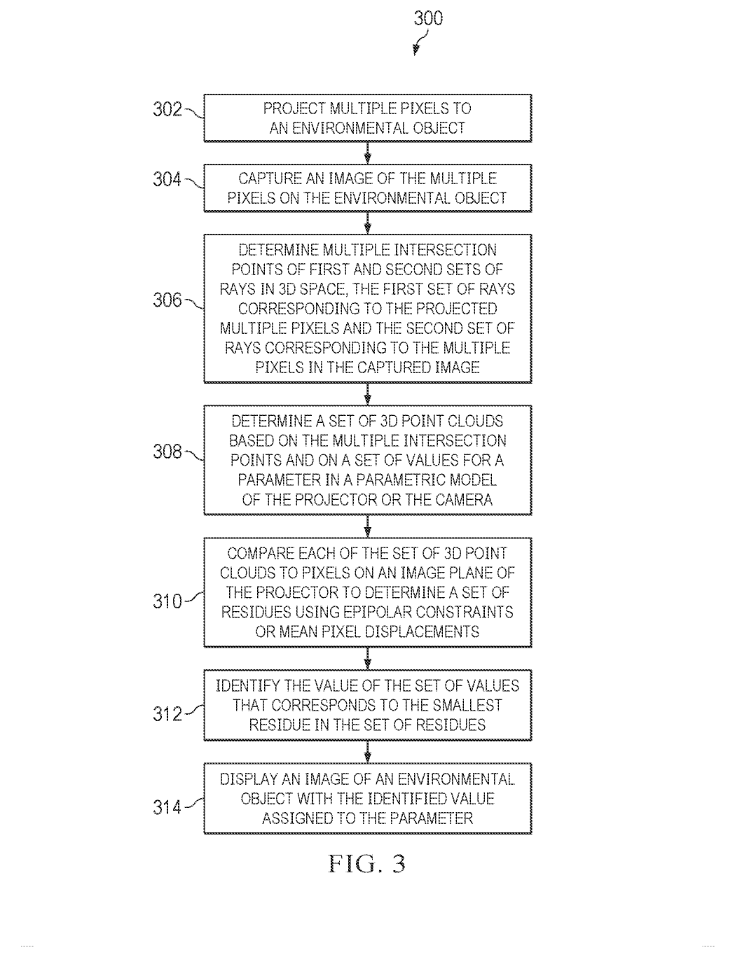

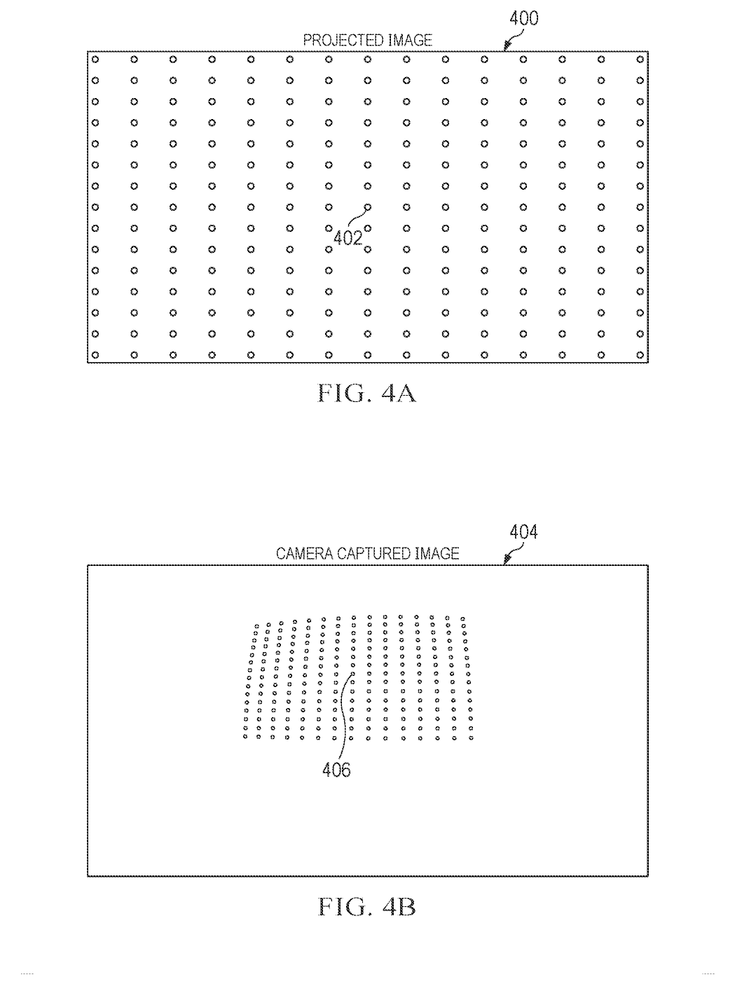

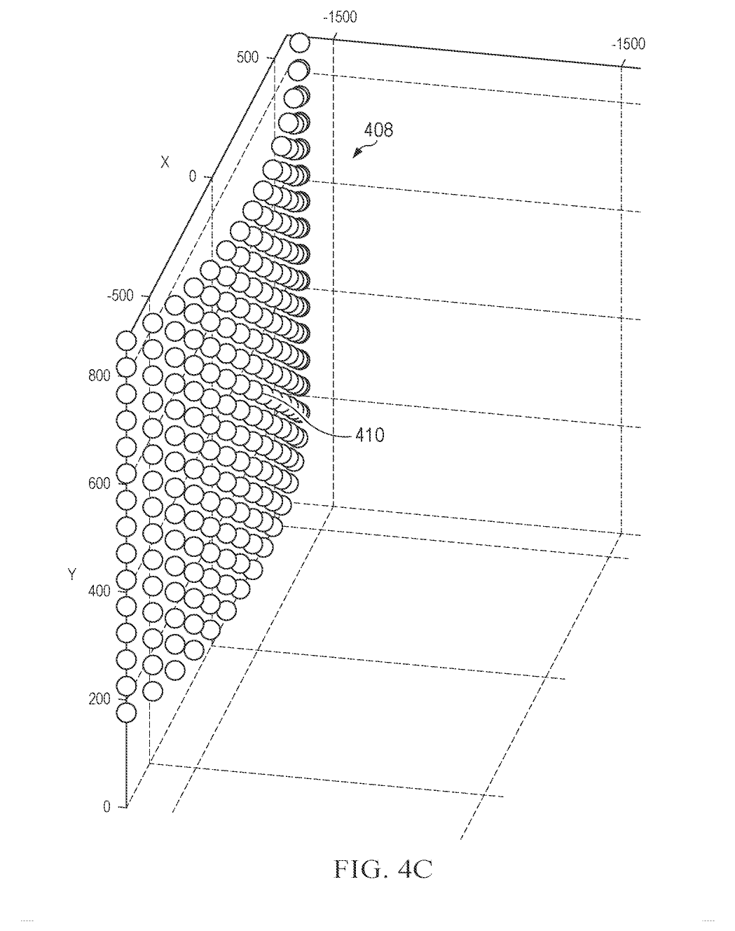

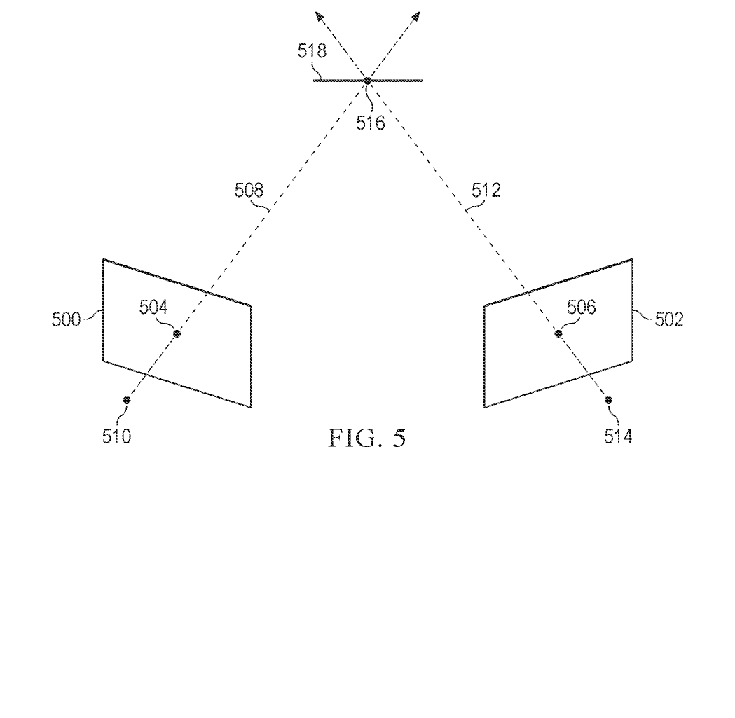

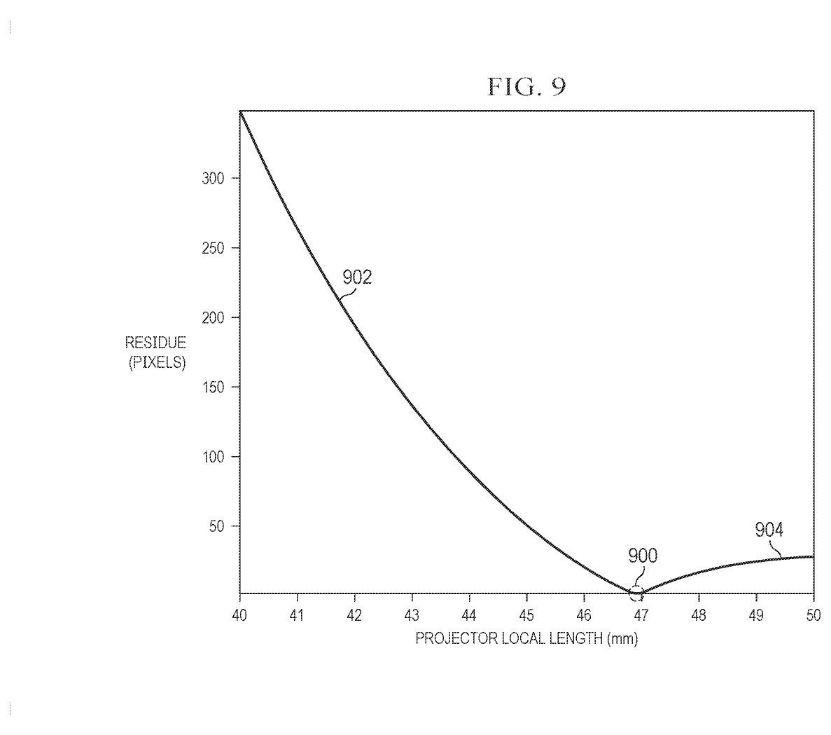

FIG. 3 is a flow diagram of a method 300 for optimizing imaging parameters of an optical device in real time, in accordance with various examples. FIGS. 4A-4C are schematic diagrams of a projected pattern, a captured image of the projected pattern, and a 3d point cloud generated using the projected pattern and the captured image, in accordance with various examples. FIGS. 5-8 are schematic diagrams of portions of methods for optimizing imaging parameters of an optical device in real time, in accordance with various examples. FIG. 9 is a graph of a portion of a method for optimizing imaging parameters of an optical device in real time, in accordance with various examples. FIGS. 2-9 are now described in parallel.

The optical devices 50, 100, and/or 200 may perform the method 300, but for purposes of discussion, the method 300 is described as being performed by the optical device 200. The method 300 may include projecting multiple pixels to an object in the environment (302). For example, the processor 202 may operate the projector 207 to project a pattern onto the environmental object 226. FIG. 4A shows an example projected pattern 400 having multiple pixels, which may be distributed in a regular pattern (as shown in FIG. 4A), a Gaussian pattern, or any other suitable type of pattern. The projected pattern 400 may include multiple pixels, including a pixel 402 that is representative of the multiple pixels, described below. The multiple projected pixels represent bright points of light projected by the projector 207.

The method 300 may include capturing an image of the multiple pixels on the environmental object (304). For example, the processor 202 may operate the camera 212 to capture an image of the pattern on the environmental object 226. FIG. 4B shows an example captured image of the projected pattern 404. The captured image of the projected pattern 404 may include the same number of pixels as the projected pattern 400. Because the captured image of the projected pattern 404 is an image of the pattern as projected onto an environmental object, the captured image of the projected pattern 404 may differ from the projected pattern 400. For example, FIG. 4B depicts the captured image of the projected pattern 404 as being curved. The captured image of the projected pattern 404 may include a pixel 406 that corresponds to the pixel 402 (e.g., the pixel 406 may not be a pixel of the camera itself), described below.

The method 300 may include determining multiple intersection points of first and second sets of rays in 3d space (306). The first set of rays corresponds to the projected multiple pixels and the second set of rays corresponds to the multiple pixels in the captured image (306). FIG. 5 depicts an example of the determination step 306. FIG. 5 shows a projector image plane 500 and a camera image plane 502. A pixel 504 is present in the projector image plane 500. This pixel 504 corresponds to the pixel 402 in the projected pattern 400. Similarly, the camera image plane 502 includes a pixel 506. This pixel 506 corresponds to the pixel 406 in the captured image of the projected pattern 404. The processor 202 may mathematically model a ray 508 originating at a center of projection 510, extending through the pixel 504, and projecting out toward infinity. (To mathematically model such a ray 508, the processor 202 may set the center of projection 510 as a geometric origin, identify the location of the pixel 504 in 3d space relative to the geometric origin, and determine a geometric ray extending through those two points.) Similarly, the processor 202 may mathematically model a ray 512 originating at a center of projection 514, extending through the pixel 506, and projecting out toward infinity. Having defined the two geometric rays 508 and 512, the processor 202 may determine their intersection point 516 in 3d space, for example, using a triangulation technique. The intersection point 516 represents one point on a surface of the environmental object 518, such as the environmental object 226. The processor 202 may determine multiple such pairs of rays, one pair for each pixel in the projected pattern 400. In this way, the processor 202 produces a set of triangulated points (e.g., intersection point 516), and this set of intersection points forms a 3d point cloud. FIG. 4C depicts an example 3d point cloud 408, which includes a pixel 410 that corresponds to the pixels 402 and 406 (the pixel 402 is projected, the pixel 410 is on the environmental object, and the pixel 406 is captured by the camera).

The method 300 includes determining a set of 3d point clouds based on the multiple intersection points and on a set of values for a parameter in a parametric model of the projector and/or the camera (308), which may be referred to herein as an imaging device parametric model. The set of intersection points obtained in step 306 form a 3d point cloud, but the 3d point cloud may change depending on the assumed parameters used to identify the set of intersection points. For example, if a first focal length of the projector 207 is assumed, the set of intersection points will form a first 3d point cloud, but if a second focal length of the projector 207 is assumed, the set of intersection points will be different and will form a second 3d point cloud. If a range of focal lengths is used to identify the set of intersection points, a corresponding set of 3d point clouds will result. Accordingly, and as described in detail above, the assumed parameters in the parametric model for the projector 207 may be varied through a range of possible values to produce multiple 3d point clouds, and the assumed parameters in the parametric model for the camera 212 may be varied through a range of possible values to produce multiple 3d point clouds. All such 3d point clouds may be included in the set of 3d point clouds that is to be analyzed as described below.

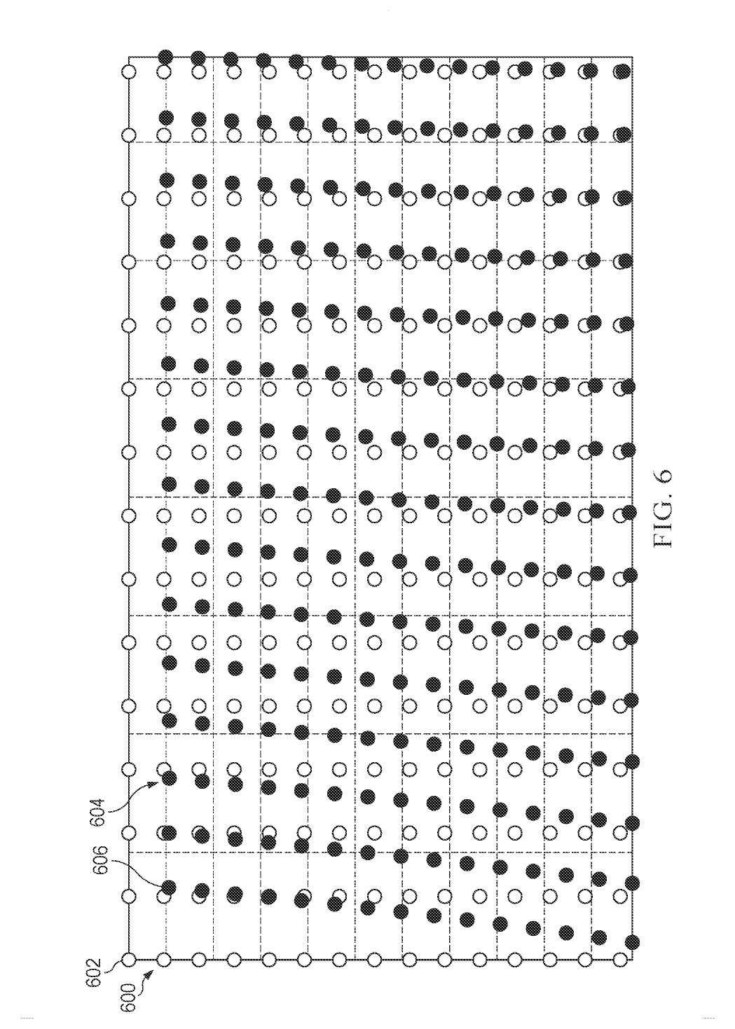

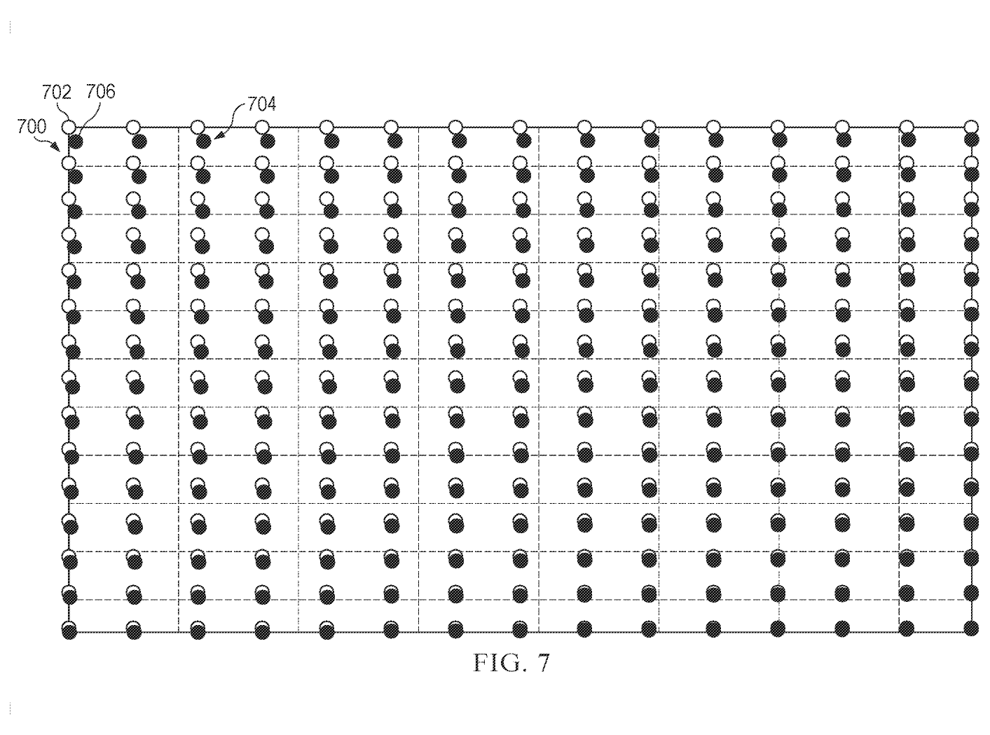

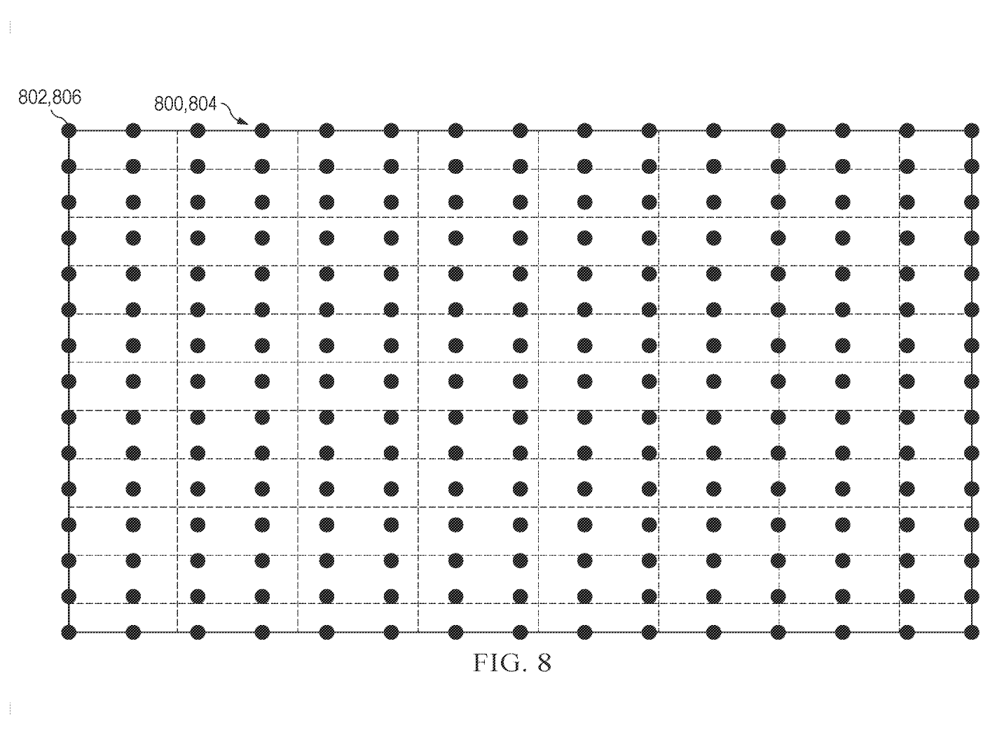

The method 300 includes comparing each of the 3d point clouds in the set of 3d point clouds to pixels on an image plane of the projector to determine a set of residues (310). Any suitable technique may be useful for calculating such residues, such as an epipolar constraint technique or a mean pixel displacement technique (310). To calculate error or residue using the epipolar constraint, each corresponding point in one image (e.g., the projected pattern 400) is mathematically projected onto the epipolar line of the other image (e.g., the captured image of the projected pattern 404) by the processor 202. The distance from each point in the captured image of the projected pattern 404 to its expected position on this line is determined. The processor 202 then sums or averages these distances across all points to provide an overall error metric, known as the epipolar constraint residue, which indicates the accuracy of the 3d point cloud being evaluated. In the mean pixel displacement technique, the processor 202 superimposes a two-dimensional representation of the 3d point cloud being evaluated over the pixels in the projector image plane 500. The processor 202 determines the distance between each pixel in the two-dimensional representation of the 3d point cloud to a corresponding pixel in the projector image plane 500. The processor 202 averages these distances across all pixels to provide an overall error metric, known as the mean pixel displacement, or the processor 202 sums these distances across all pixels to provide a total pixel displacement. FIGS. 6-8 depict examples of such pixel displacement determinations. Each of FIGS. 6, 7, and 8 represents a different 3d point cloud being compared against a standard to determine which of the three 3d point clouds produces the smallest residue (error). The parameters associated with the 3d point cloud producing the smallest error are selected as the assumed parameters to be used during future operation. FIG. 6 depicts a representation 600 of a projector image plane including multiple pixels. A projector image plane is the physical surface or virtual plane where the projected light from the projector lens converges to form a clear and focused image. The representation 600 is a 2d model of such a projector image plane, with the white dots representing the multiple pixels that constitute the two-dimensional model. The pixels represented by the white dots include pixel 602. The representation 600 is the standard against which the 3d point clouds, and more specifically, the 2d representations of the 3d point clouds, are to be compared to identify the 3d point cloud with the smallest residue. FIG. 6 also depicts a 2d representation of a 3d point cloud being evaluated, denoted as representation 604, superimposed over the representation 600. The representation 604 is a 2d model of the 3d point cloud and includes multiple black dots representing the multiple pixels that constitute the 2d model. The pixels represented by the black dots include pixel 606. The example pixel 602 from representation 600 corresponds to the example pixel 606 from representation 604. The distance between pixels 602 and 606, which would ideally be superimposed one on top of the other, is significant. Other pairs of corresponding pixls also include significant distances between the pixels. The processor 202 may sum or average these distances to produce a total residue for the 3d point cloud being evaluated in FIG. 6. FIG. 7 depicts a 3d point cloud representation 704 (black dots), which differs from the representation 600, superimposed over a projector image plane representation 700 (white dots). The corresponding pixels 702 and 706 are closer to each other than are the pixels 602, 606 in FIG. 6. However, a distance between pixels 702 and 706 still remains, as is the case for multiple other pairs of pixels shown in FIG. 7. The processor 202 may sum or average these distances to produce a total residue for the 3d point cloud being evaluated in FIG. 7. FIG. 8 depicts a 3d point cloud representation 804 (black dots), which differs from the representations 600 and 704, superimposed over a projector image plane representation 800 (white dots). The corresponding pixels 802 and 806 match each other with no distance between the pixels. The remaining pairs of pixels match each other as well. The processor 202 may determine the residue for the 3d point cloud being evaluated in FIG. 8 to be zero. The processor 202 may repeat this process for each 3d point cloud in the set of 3d point clouds, producing a residue value for each 3d point cloud in the set of 3d point clouds.

The method 300 may include identifying the value or set of values that corresponds to the smallest residue in the set of residues (312). After the processor 202 has produced a set of residues, each residue corresponding to a different 3d point cloud in the set of 3d point clouds, the processor 202 may identify the lowest residue in the set of residues. FIG. 9 is a graph plotting an example set of residues (y-axis) as a function of example projector focal lengths (x-axis). In this example, the residue (numeral 902) decreases as projector focal length increases, until a nadir 900 is reached at a projector focal length of 46.95 mm. The residue (numeral 904) then rises as projector focal length increases beyond 46.95 mm. Thus, the lowest residue corresponds to the 3d point cloud generated by an assumed focal length parameter of 46.95 mm. The processor 202 may update the projector 207 parametric model with 46.95 mm as the assumed focal length. Going forward, and until the method 300 is repeated, the processor 202 may model environmental objects using an assumed projector focal length 46.95 mm, which will reliably produce accurate results. For example, the processor 202 may use an assumed focal length of 46.95 mm to model the direction of projected light rays, allowing the processor 202 to triangulate in 3d space the intersections of the projected light rays with light rays captured at the camera to generate 3d point clouds. If the actual projector focal length is later changed, the processor 202 repeats the method 300, causing the projector parametric model to be updated accordingly.

The approach described above includes determining a set of 3d point clouds, determining a set of corresponding residues, and then identifying the 3d point cloud with the lowest residue. However, in some examples, the processor 202 determines and compares residues as each 3d point cloud is determined, rather than after the set of 3d point clouds has been determined. For example, the processor 202 may generate a first 3d point cloud using an assumed projector focal length of 45 mm and may determine the associated residue for that first 3d point cloud to be 0.005 pixels (FIG. 9). The processor 202 may then generate a second 3d point cloud using an assumed projector focal length of 44 mm and may determine the associated residue for that second 3d point cloud to be 0.008 pixels (FIG. 9). Because the residue associated with the second 3d point cloud is greater than the residue associated with the first 3d point cloud, the processor 202 may determine that the residue may converge to zero is the assumed projector focal length was increased instead of decreased. Accordingly, the processor 202 may generate a third 3d point cloud using an assumed projector focal length of 46 mm, and may determine the associated residue for the third 3d point cloud to be 0.002 pixels, which indicates that the residue is decreasing as projector focal length increases. The processor 202 may generate a fourth 3d point cloud using an assumed projector focal length of approximately 46.95 mm, which produces a residue of zero (nadir 900, FIG. 9), and the processor 202 may thus store the assumed projector focal length of 46.95 mm in the parametric model for the projector 207. In some examples, the processor 202 may generate a fifth 3d point cloud using an assumed projector focal value greater than 46.95 mm, to determine whether the residue for the fifth 3d point cloud remains at zero, remains relatively low, or rises substantially.

This approach is efficient, as only four 3d point clouds are generated before the 3d point cloud with the lowest residue is identified. Had the residue associated with the second 3d point cloud been smaller than that of the first 3d point cloud, the processor 202 may have continued calculating residues for 3d point clouds with decreasing projector focal lengths. This approach may be referred to herein as the “stepwise approach.”

In some examples, the processor 202 evaluates sweeps through a range of possible values for multiple assumed parameters, instead of a single assumed parameter. For example, as described in detail above, the processor 202 may generate a set of 3d point clouds, with each 3d point cloud generated using a different combination of projector focal length and camera focal length. Thus, for instance, the processor 202 may hold the value for assumed projector focal length constant at 20 mm while sweeping through the range of possible values for the assumed camera focal length, optionally calculating residues as each 3d point cloud is generated. The processor 202 may then increment the value for the assumed projector focal length from 20 mm to 21 mm and repeat the sweep through the range of possible values for the assumed camera focal length, optionally calculating residues as each 3d point cloud is generated. If incrementing the assumed projector focal length from 20 mm to 21 mm consistently produces larger residues than those produced when the assumed projector focal length was at 20 mm, then the processor 202 may adjust the assumed projector focal length in the other direction, from 21 mm to 19 mm, and may repeat the sweep through the range of possible values for the assumed camera focal length. This approach, which may be referred to herein as the “sweeping approach,” may be combined with the stepwise approach described above, or this approach may be performed by determining residues for multiple 3d point clouds before comparing the residues to identify a smallest residue. Any and all such approaches are contemplated and included in the scope of this disclosure.

The method 300 may include displaying an image of an environmental object with the identified assumed parameter value assigned to a corresponding parameter in the parametric model of the projector or the camera (314). For example, the processor 202 may use the techniques described above with reference to steps 302-312 that the value for the assumed projector focal length in the projector parametric model that produces the 3d point cloud with the smallest residue is 20 mm. The processor 202 may assign the value of 2 mm to the assumed projector focal length in the projector parametric model. The processor 202 may subsequently display an image of an environmental object modeled based on the assumed projector focal length of 2 mm. The processor 202 may repeat the method 300 automatically and periodically, or in response to a user request.

In some examples, when evaluating multiple assumed parameters at a time, the combination of assumed parameters that produces the 3d point cloud with the lowest residue (e.g., a projector focal length of 30 mm and a camera focal length of 40 mm) may differ from the assumed parameter value (e.g., a projector focal length of 35 mm) that produces the 3d point cloud with the lowest residue when only that assumed parameter value is being evaluated.

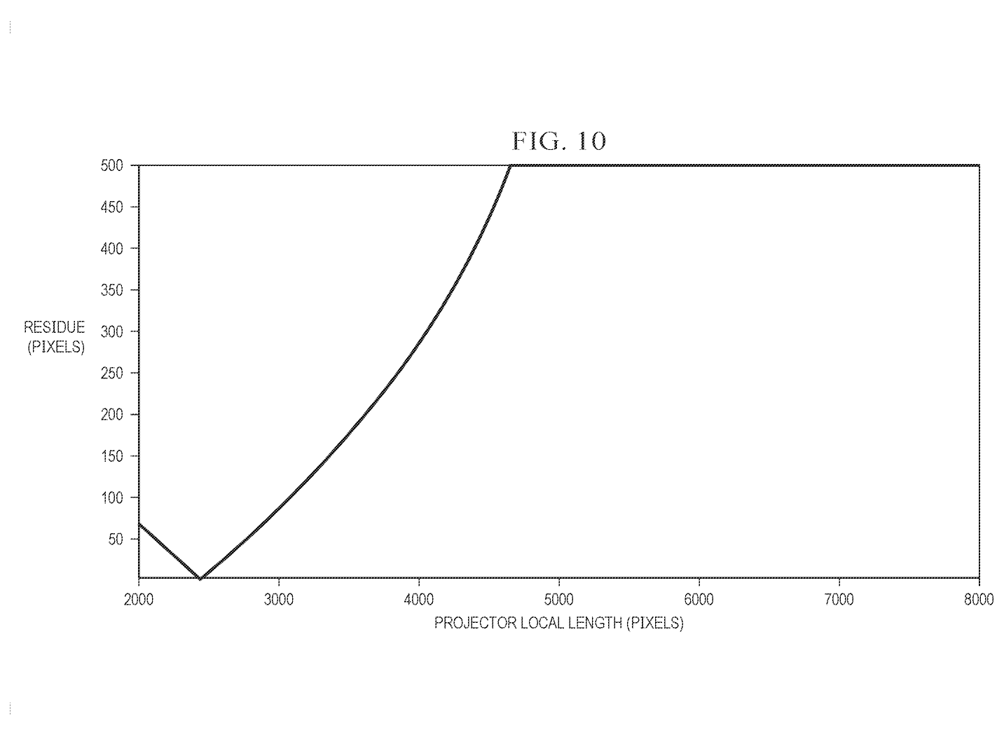

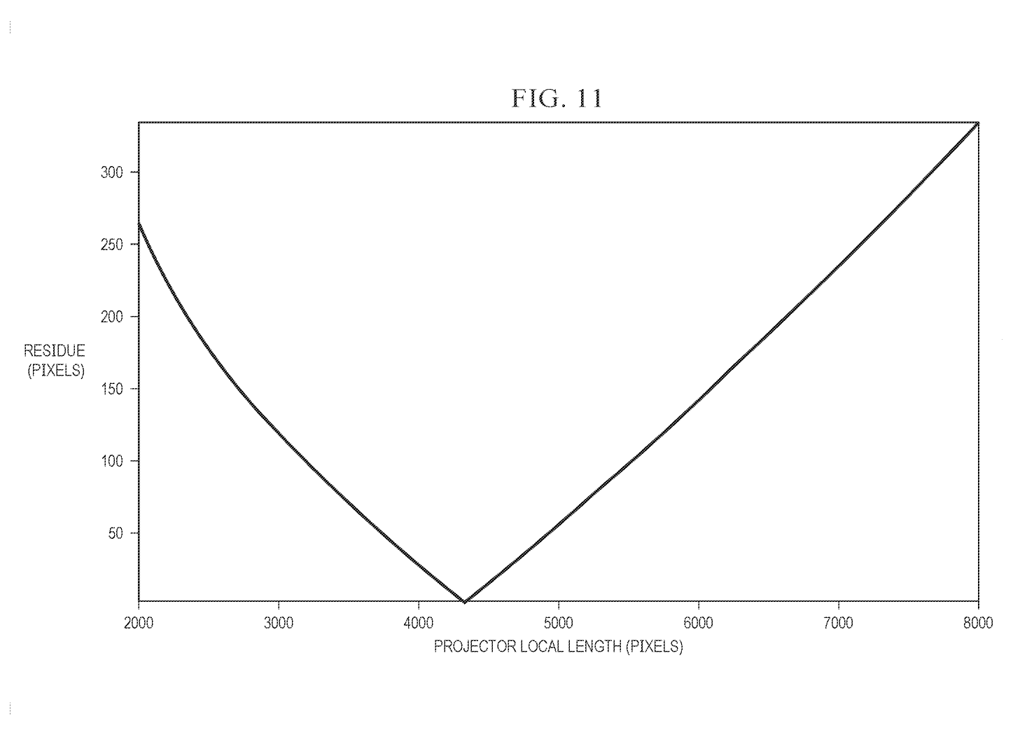

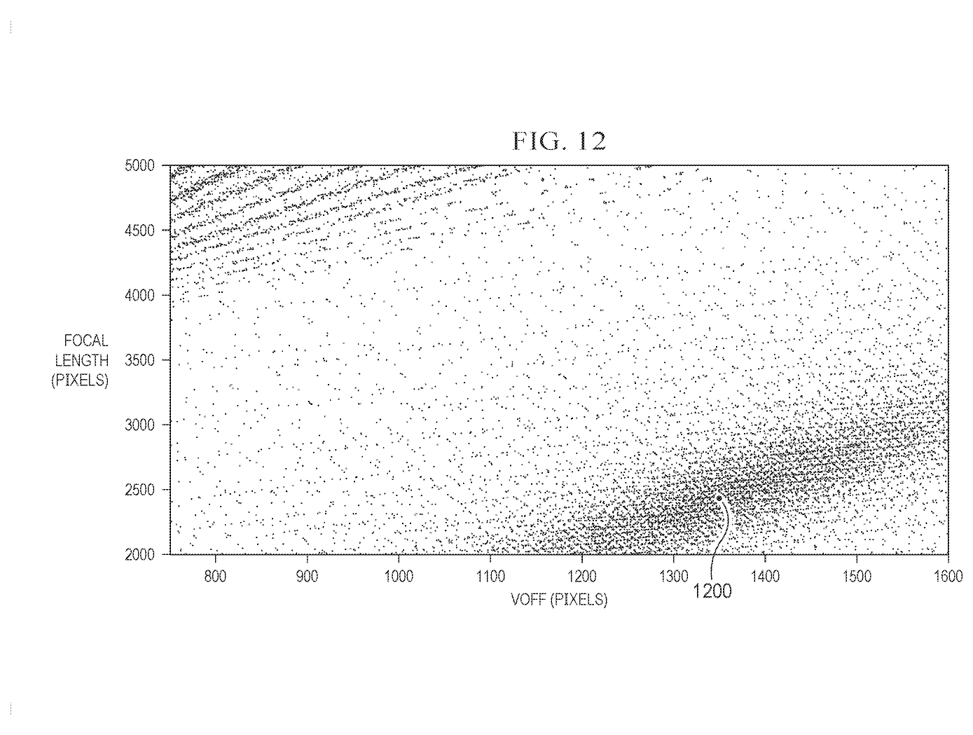

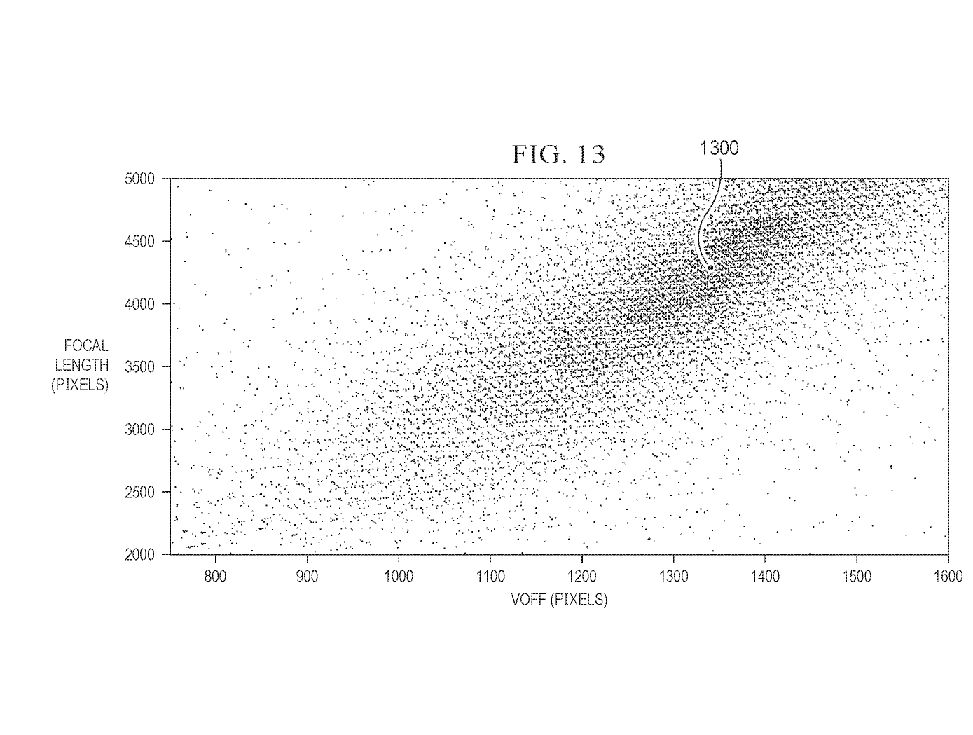

FIGS. 10-13 provide example applications of the techniques described above. FIG. 10 is a graph including projector focal length (in pixels) on the x-axis and residue (in pixels) on the y-axis. The techniques described above, such as the stepwise and sweeping approaches, may be used to determine that the residue nadir of the graph (i.e., 0 pixels) is produced by a focal length of 2437 pixels. This finding is validated by the calculated throw ratio of 1.269 associated with this focal length closely approximating the actual, known throw ratio of 1.2625. Similarly, in FIG. 11, which is a graph including projector focal length (in pixels) on the x-axis and residue (in pixels) on the y-axis, the stepwise and/or sweeping approaches may be used to determine that the residue nadir of the graph (i.e., 0 pixels) is produced by a focal length of 4325 pixels. This finding is validated by the calculated throw ratio of 2.252 associated with this focal length closely approximating the actual, known throw ratio of 2.25. FIG. 12 and 13 are contour plots depicting example applications of the techniques described above, for two parameters simultaneously (e.g., focal length and vertical offset).

In FIG. 12, the x-axis depicts vertical offset in pixels and the y-axis depicts focal length in pixels. Both the vertical offset and focal length parameters must be selected so as to produce the lowest possible residue. As point 1200 indicates, the vertical offset is determined to be 1350 pixels, and the focal length is determined to be 2435 pixels. These findings are validated by the calculated vertical offset percentage of 150% precisely matching the actual vertical offset of 150%, and the calculated throw ratio of 1.2682 closely approximating the actual throw ratio of 1.2625. In FIG. 13, the x-axis depicts vertical offset in pixels and the y-axis depicts focal length in pixels. Both the vertical offset and the focal length parameters must be selected so as to produce the lowest possible residue. As point 1300 indicates, the vertical offset is determined to be 1340 pixels, and the focal length is determined to be 4285 pixels. These findings are validated by the calculated vertical offset percentage of 148.14% closely approximating the actual vertical offset percentage of 150%, and the calculated throw ratio of 2.231 closely approximately the actual throw ratio of 2.25.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

In this description, unless otherwise stated, “about,” “approximately” or “substantially” preceding a parameter means being within +/- 10 percent of that parameter. Modifications are possible in the described examples, and other examples are possible within the scope of the claims.

What is claimed is:

1. A device, comprising:
a projector configured to project a pattern;
a camera configured to capture an image of a reflection of the projected pattern; and
a processor coupled to the projector and to the camera, the processor configured to:
determine multiple intersection points of first and second sets of rays in 3d space, the first set of rays corresponding to the projected pattern having and the second set of rays corresponding to the pattern in the captured image;
determine a set of 3d point clouds responsive to the multiple intersection points and a set of values for a parameter in a parametric model of the projector or the camera;
compare each of the set of 3d point clouds to a target set of pixels to determine a set of residues;
select a value of the set of values responsive to the set of residues; and
display an image of an object in an environment of the device with the selected value assigned to the parametric model.

2. The device of claim 1, wherein the processor is configured to compare each point in a 3d point cloud of the set of 3d point clouds to a corresponding pixel in the image of the projected pattern.

3. The device of claim 1, wherein the set of residues includes an epipolar constraint residue.

4. The device of claim 1, wherein the set of residues includes a mean pixel displacement.

5. The device of claim 1, wherein the processor is configured to select each value in the set of values to cause the residue for each successive comparison of the comparisons to be reduced.

6. The device of claim 1, wherein the parameter is a first parameter, and wherein the processor is configured to further determine the set of 3d point clouds responsive to a second parameter in the parametric model of the projector or the camera.

7. The device of claim 6, wherein the processor is configured to select a different combination of values for the first and second parameters to determine each 3d point cloud in the set of 3d point clouds.

8. The device of claim 7, wherein the processor is configured to identify the combination of values for the first and second parameters that results in a target residue and to generate the image of the object with the identified combination of values assigned to the parametric model.

9. The device of claim 1, wherein the parameter is selected from the group consisting of a focal length of the projector or the camera, a principal point of the projector or the camera, a resolution of the projector or the camera, and a distortion of the projector or the camera.

10. A non-transitory, computer-readable medium storing executable instructions which, when executed by a processor, cause the processor to:
obtain a set of triangulated points in 3d space responsive to a pattern having multiple projected pixels and a captured image of a reflection of the pattern having multiple projected pixels, the multiple projected pixels in the captured image corresponding to the pattern;
determine a first three-dimensional (3d) point cloud responsive to the set of triangulated points in 3d space and on a first value for a parameter in a parametric model of an imaging device;
determine a second 3d point cloud responsive to the set of triangulated points in 3d space and on a second value for the parameter;
determine first and second residues by comparing the first and second 3d point clouds, respectively, to a target set of pixels;
determine that the first residue is smaller than the second residue; and
generate an image of an environmental object with the first value assigned to the parametric model.

11. The medium of claim 10, wherein the instructions cause the processor to:
determine a third 3d point cloud responsive to the set of triangulated points in 3d space and on a third value for the parameter responsive to the second residue being smaller than the first residue; and
determine a fourth 3d point cloud responsive to the set of triangulated points in 3d space and on a fourth value for the parameter responsive to the second residue being larger than the first residue.

12. The medium of claim 10, wherein the parameter is a first parameter, and wherein the instructions cause the processor to determine the first 3d point cloud responsive to the set of triangulated points in 3d space, the first value for the first parameter, and a third value for a second parameter in the parametric model.

13. The medium of claim 12, wherein, to identify the first and third values, the instructions cause the processor to sweep through a first set of possible values for the first parameter and a second set of possible values for the second parameter.

14. The medium of claim 13, wherein, to identify the first and third values, the instructions cause the processor to sweep through the second set of possible values for the second parameter while holding constant a possible value in the first set of possible values.

15. The medium of claim 10, wherein the imaging device is a projector or a camera.

16. The medium of claim 10, wherein the parameter is selected from the group consisting of a focal length of the imaging device, a principal point of the imaging device, a resolution of the imaging device, and a distortion of the imaging device.

17. A method, comprising:
determining, by a processor, a set of three-dimensional (3d) point clouds, the 3d point cloud in the set of 3d point clouds responsive to different values for a parameter in an imaging device parametric model;
determining, by the processor, that a first 3d point cloud of the 3d point clouds most closely matches a target set of pixels; and
producing, by the processor, an image of an environmental object with the value used to determine the first 3d point cloud assigned to the imaging device parametric model.

18. The method of claim 17, wherein determining that the first 3d point cloud most closely matches the target set of pixels comprises determining one of an epipolar constraint residue and a mean pixel displacement.

19. The method of claim 17, further comprising:
assigning the value used to determine the first 3d point cloud to the imaging device parametric model responsive to determining that second and third 3d point clouds in the set of 3d point clouds match the target set of pixels less closely than the first 3d point cloud, the value used to determine the first 3d point cloud being in between a second value for the parameter used to determine the second 3d point cloud and a third value for the parameter used to determine the third 3d point cloud.

20. The method of claim 17, wherein the parameter is selected from the group consisting of a focal length of an imaging device, a principal point of the imaging device, a resolution of the imaging device, and a distortion of the imaging device.
